(19) United States
(12) Patent Application Publication
(10) Pub. No.: US 2010/0030540 A1
(43) Pub. Date: Feb. 4, 2010

(54) SYSTEM AND METHOD FOR RECONSTRUCTING TRAFFIC ACCIDENT

(75) Inventors: Jong Woo CHOI, Daejeon (KR); Oh Cheon KWON, Suwon-si (KR); Hyun Suk KIM, Daejeon (KR); Dong Yong KWAK, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/512,565

(22) Filed: Jul. 30, 2009

(30) Foreign Application Priority Data
Aug. 4, 2008 (KR) 10-2008-0076097

(51) Int. Cl. G06G 7/70; G06G 7/76; G01S 1/00

(52) U.S. Cl. 703/8; 342/357.09; 701/35

(57) ABSTRACT

Provided is a system and method for automatically reconstructing a traffic accident. The accident reconstructing system includes a data collecting unit, a geographical data providing unit, and an accident analyzing unit. The data collecting unit collects/transmits accident-related data according to the occurrence of a traffic accident. The geographical data providing unit transmits the geographical data of the neighborhood of the accident site. The accident analyzing unit reconstructs the traffic accident virtually on the basis of the data outputted from the data collecting unit and the geographical data providing unit.

### CROSS-REFERENCE TO RELATED APPLICATIONS

This application claims priority under 35 U.S.C. §119 to Korean Patent Application No. 10-2008-0076097, filed on Aug. 4, 2008, in the Korean Intellectual Property Office, the disclosure of which is incorporated herein by reference in its entirety.

### TECHNICAL FIELD

The following disclosure relates to a system and a method for reconstructing a traffic accident, and in particular, to a system and a method for automatically reconstructing the circumstances of a traffic accident in consideration of driver data, weather data, and external condition data received from roadside sensors, as well as on the basis of blackbox data and Geographic Information System (GIS) data.

### BACKGROUND

In the event of a traffic accident, the circumstances of the traffic accident are reconstructed through on-site investigation to determine the final positions of vehicles involved, and the damage to the vehicles, and debris from the damage, and skid marks left on the road, and collect witness statements. However, consolidating and constructing the respective data is low in accuracy, inconvenient and time consuming.

In order to overcome the above limitations, a vehicle blackbox for accident reconstruction has been introduced and an automation program (hereinafter referred to as an accident reconstruction program) has been developed to reconstruct traffic accidents based on vehicle blackbox data.

A vehicle blackbox has a function for recording the status of vehicle components and data on how the vehicle was controlled by the driver. Therefore, in the event of a traffic accident, the vehicle blackbox can be used to collect data for accident reconstruction and analysis for the reason why the accident occurred. A vehicle blackbox may also provide basic data that can be used to improve safety and analyze the causes of vehicle component failure, by storing various vehicle movement data and the driver control data. Thus, a vehicle blackbox may be used to detect critical vehicle defects and prevent traffic accidents.

To reconstruct the circumstances of a traffic accident, the vehicle blackbox stores accident-related data from a certain point before the accident time to a certain point after the accident time in its electromagnetic recording medium. Therefore, the use of the vehicle blackbox makes clear evidence for a traffic accident be presented in order to settle accident disputes if there were no witnesses, thus making it possible to protect a driver without fault. Also, police and insurance company representatives who are called to the scene of an accident can collect vehicle blackboxes, which makes it easy to reconstruct the accident circumstances.

However, the accident circumstance reconstruction method using a vehicle blackbox reconstructs the circumstances of a traffic accident solely on the basis of internal vehicle data, and thus has a limitation in accurate reconstructing of the complete accident circumstances, which inevitably involve the external factors.

Since traffic accidents are caused by not only internal factors of a vehicle such as equipment failure and driver error, but also external factors of the vehicle (e.g., collision with another vehicles or an obstacle, and road, geographical, and weather conditions), it is necessary to analyze the circumstances of a traffic accident through additional on-site investigation after the traffic accident.

Also, it is not very convenient for an operator using an accident reconstruction program because the operator should manually perform the tasks of constructing an accident environment in a virtual space, arranging accident-involved objects (e.g., vehicles, people, and obstacles) in the virtual accident environment, estimate the motion quantities of the arranged objects and the movement trajectories of the arranged objects over time, and input the resulting parameters into the accident reconstruction program.

### SUMMARY

In one general aspect, a system for automatically reconstructing a traffic accident includes: a data collecting unit collecting/transmitting accident-related data according to the occurrence of a traffic accident; a geographical data providing unit transmitting the geographical data of the neighborhood of the accident site; and an accident analyzing unit reconstructing the traffic accident virtually on the basis of the data outputted from the data collecting unit and the geographical data providing unit.

In another general aspect, a method for automatically reconstructing a traffic accident includes: collecting accident-related data according to the occurrence of a traffic accident; analyzing necessary data extracted from the accident-related data; and reconstructing the traffic accident virtually on the basis of the analyzed data.

Other features and aspects will be apparent from the following detailed description, the drawings, and the claims.

### BRIEF DESCRIPTION OF THE DRAWINGS

FIG. 1 is a block diagram of an accident reconstructing system according to an exemplary embodiment of the present invention.

FIG. 2 is a flow diagram illustrating data collecting operations for an accident reconstructing process according to an exemplary embodiment.

FIG. 3 is a flow diagram illustrating data analyzing operations and accident reconstructing operations for the accident reconstructing process according to an exemplary embodiment.

FIGS. 4A to 4D are diagrams illustrating a process for reconstructing a traffic accident by constructing a virtual accident environment according to an exemplary embodiment.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/of systems described herein will be suggested to those of ordinary skill in the art. Also, descriptions of well-known functions and constructions may be omitted for increased clarity and conciseness.

Basically, in order to remove the inconvenience of manual tasks and achieve the reliability of accident reconstruction, the exemplary embodiments collect not only geographical data of the neighborhood of the accident site and data of a vehicle blackbox installed in each of one or more accident-involved vehicles, but also other collectable data such as weather data, driver data, and road condition data from a roadside sensor immediately after the accident time; analyze the collected data to automatically construct a basic accident environment; and extract mechanical parameters related to the collision/motion quantities of the vehicles and mechanical factors affecting the traffic accident from the collected/analyzed data to reconstruct the accident circumstances.

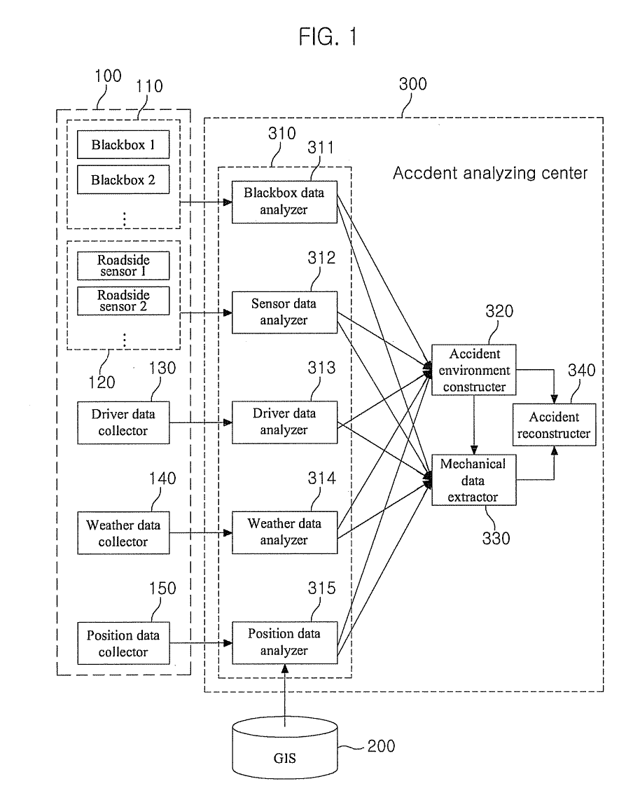

FIG. 1 is a block diagram of an accident reconstructing system according to an exemplary embodiment of the present invention.

Referring to FIG. 1, an accident reconstructing system according to exemplary embodiments includes a data collecting unit 100, a Geographic Information System (GIS) 200, and an accident analyzing center 300.

The data collecting unit 100 collects and outputs various data related to the occurrence of a traffic accident. The data collecting unit 100 includes a vehicle blackbox 110, a roadside sensor 120, a driver data collector 130, a weather data collector 140, and a position data collector 150.

The vehicle blackbox 110 is installed in each vehicle to continuously collect the driving data and the status data (e.g., self-diagnosis data, engine operation status data, and component status data) of the vehicle. When a traffic accident occurs, the vehicle blackbox 110 transmits the blackbox data for a predetermined time interval around the time of the accident (e.g., from 3 minutes before the accident to 30 seconds after the accident) to the accident analyzing center 300.

Herein, the blackbox data of the blackboxes 110 installed in all the vehicles involved in the traffic accident (e.g., 4 vehicles in the event of a triple rear-end collision accident) are transmitted to the accident analyzing center 300.

Preferably, the blackbox data include image data of external environments around each vehicle. The images of the external environments are captured at various angles by cameras installed at the periphery of the vehicle (e.g., the centers of the front/rear bumpers of the vehicle and the certain points of the left/right sides of the vehicle). The image data also include image data of other vehicles, people, and objects that approach the vehicle. Traffic accidents may be caused by other factors than direct collisions between vehicles or between a vehicle and an object, such as collisions due to operations to avoid collisions with other vehicles or pedestrians. Therefore, the image data on the external environment of the vehicle may greatly assist in the easy detection of more accurate causes of the traffic accident.

The roadside sensor 120 is located on the roadside to transmit/communicate data to/with the accident analyzing center 300 through a wired or wireless network. The roadside sensor 120 collects accident circumstance data according to the detection of roadside conditions (i.e., external condition data of the vehicle at the accident time) and transmits the collected accident circumstance data to the accident analyzing center 300. Herein, the roadside conditions may include the status of nearby traffic lights, surface condition of the road, road construction conditions, conditions of previous accidents, if any, driving speed limit at the accident time, etc.

Image data may be included in the data collected by the roadside sensor 120. The image data can be used to detect the peripheral conditions at the accident time more accurately. The image data may include data on the vehicle traffic status in the neighborhood of the accident site and data on the status of accident victims after the accident. Therefore, the image data may also be used to aid rapid cleanup and restoration of accident scenes.

Thus, in consideration of the cost for installing a plurality of image capturing cameras on the roadside, the roadside sensor 120 may be configured to collect limited data (e.g., data on the traffic status of the neighborhood of the accident site) through an ultrasonic sensor and an RFID sensor. Preferably, the roadside sensor 120 includes as many sensors as possible, such as a camera, an ultrasonic sensor, and an RFID sensor, for more accurate collection of the external condition data.

The roadside sensor 120 may detect the traffic accident and transmit the external condition data to the accident analyzing center 300 in the following exemplary ways.

In an exemplary way, when the accident vehicle notifies the accident occurrence to the roadside sensor 120 adjacent to the accident site, the roadside sensor 120 transmits the external condition data for a certain time interval around the accident time to the accident analyzing center 300. In another exemplary way, when the accident vehicle notifies the accident occurrence to the accident analyzing center 300, the accident analyzing center 300 transmits an external condition data transmission command to the roadside sensor 120 adjacent to the accident site and the roadside sensor 120 transmits the external condition data for the certain time interval around the accident time to the accident analyzing center 300 in response to the external condition data transmission command.

In another exemplary way, the roadside sensor 120 may have the intelligence to detect the accident occurrence through the collected data and transmit the external condition data for a certain time interval around the accident time to the accident analyzing center 300. However, it will be understood that the ways to transmit the external condition data from the roadside sensor 120 to the accident analyzing center 300 are not limited to the aforesaid exemplary ways.

The driver data collector 130 collects data on a driver of the accident vehicle and transmits the vehicle driver data to the accident analyzing center 300.

For example, the driver data collector 130 may collect data on the drowsy status of the driver by detecting the eyelid motion cycle of the driver through a camera installed in the vehicle. Also, the driver data collector 130 may collect data on the fatigue status or the driving status (e.g., reckless driving and safe driving) of the driver by detecting a change in the posture and the driving posture of the driver through a wide-range pressure sensor installed at the driving seat. Also, the driver data collector 130 may collect data on driver stress by detecting a change in the temperature of the driver through a temperature sensor installed at the vehicle handle. In this manner, the driver data collector 130 may collect various physical status data of the driver. Also, the driver data collector 130 may collect data on the vehicle driving pattern of the driver by collecting speed change data from the speedometer of the vehicle.

In the aforesaid exemplary embodiments, the driver data collector 130 is separated from the vehicle blackbox 110. However, various changes and modifications may be made in the configurations of the driver data collector 130 and the vehicle blackbox 110. In other exemplary embodiments, the driver data collector 130 may be integrated into the vehicle blackbox 110. In further exemplary embodiments, the vehicle blackbox 110 may be configured to also perform the aforesaid operation of the driver data collector 130 on behalf of the driver data collector 130.

The weather data collector 140 collects the weather data of the accident site by searching a weather database of the national meteorological administration or by receiving weather image data from a satellite, and transmits the collected weather data to the accident analyzing center 300.

The weather data collector 140 has no limitation in its position. In exemplary embodiments, the weather data collector 140 may be a weather data collecting system controlled by the national meteorological administration. In other exemplary embodiments, the weather data collector 140 may be disposed in the vehicle or in the accident analyzing center 300 or at any other position.

The position data collector 150 collects the position data of the vehicle at the accident time through a Global Positioning System (GPS) (not illustrated) and transmits the collected position data to the accident analyzing center 300.

Embodiment of the position data collector 150 of the present invention is not limited to the above mentioned example. In other exemplary embodiments, the position data may be collected/transmitted by the vehicle blackbox 110 or by the roadside sensor 130 installed in the neighborhood of the accident site.

The GIS 200 provides geographical data including geographic data corresponding to spatial position data and related attribute data (e.g., height and inclination). The GIS 200 transmits the geographical data (i.e., GIS data) of the neighborhood of the accident site to the accident analyzing center 300 in response to the geographical data request of the accident analyzing center 300.

The accident analyzing center 300 includes an accident data analyzer 310, an accident environment constructer 320, a mechanical data extractor 330, and an accident reconstructer 340.

The accident data analyzer 310 analyzes various data received from the data collecting unit 100, for reconstructing the traffic accident. The accident data analyzer 310 includes a blackbox data analyzer 311, a sensor data analyzer 312, a driver data analyzer 313, a weather data analyzer 314, and a position data analyzer 315.

The blackbox data analyzer 311 analyzes whether any internal defect and any driver input existed at the time of the accident, on the basis of the driving status data and the vehicle status data included in the blackbox data of the vehicle blackbox 110, and transmits the analysis results to the accident environment constructer 320 and the mechanical data extractor 330.

If not only the internal vehicle data (e.g., the vehicle status data and the driving status data) but also image data of the external environments of the vehicle are included in the blackbox data, the blackbox data analyzer 311 also analyzes the image data to detect an object causing the traffic accident, the access path of the object, and a change in the driving status of the vehicle according to the access of the object (e.g., sudden turn or sudden stop), in consideration of the position and angle of each camera installed at the vehicle.

The sensor data analyzer 312 extracts data on the traffic light status, the arrangement relationship between objects (e.g., other vehicles, pedestrians, and geographical objects) in the neighborhood of the accident site, the final positions of the accident-involved vehicles, the peripheral obstacles, the road surface status, and the road conditions from the external condition data received from the roadside sensor 120, analyzes the extracted data, and transmits the analysis results to the accident environment constructer 320 and the mechanical data extractor 330.

As described above, image data may be included in the data transmitted from the roadside sensor 120. The image data may include not only the accident circumstance data but also data on the vehicle traffic status in the neighborhood of the accident site and data on the status of accident victims after the traffic accident. Therefore, the image data may also be used to aid rapid cleanup and restoration of accident scenes. It is preferable that the accident analyzing center 300 first notify the accidence occurrence to adjacent medical institutions and ambulances in order to rapidly provide proper saving treatments and increase a life saving rate when the status of the accident victims are detected.

The driver data analyzer 313 analyzes the physical status (e.g., the drowsy status) of the driver and/or the driving patterns (e.g., sudden acceleration and sudden braking) on the basis of the received driver data, and transmits the analyzed data to the accident environment constructer 320 and the mechanical data extractor 330.

The weather data analyzer 314 extracts the accident-causing weather factors (e.g., heavy fog, rainfall and snowfall) in the neighborhood of the accident site from the received weather data, and transmits the extracted data to the accident environment constructer 320 and the mechanical data extractor 330.

The position data analyzer 315 collects the position data for a certain period (e.g., 1 minute) before the accident time from the position data collector 150, and analyzes the movement trajectories of the accident-involved vehicles. Also, the position data analyzer 315 receives the geographical data (i.e., the GIS data) of the neighborhood of the accident site from the GIS 200, analyzes the geographical data of the accident area (e.g., the sharp curve in the road), analyzes the physical effects according to the geographical features (e.g., the direction and the magnitude of centrifugal force applied thereto), and transmits the analyzed data to the accident environment constructer 320 and the mechanical data extractor 330.

The accident environment constructer 320 constructs a three-dimensional basic accident environment on the basis of the position data, the geographical data, and the weather data; synthesizes the blackbox data, the roadside sensor data, the driver data, and the geographical data; and arranges accident-related objects (i.e., adjacent objects such as vehicles, pedestrians, and traffic lights) in the three-dimensional basic accident environment, thereby constructing a virtual accident environment.

The mechanical data extractor 330 synthesizes various data (e.g., the driver data, the weather data, the position data, and the GIS data) on the basis of the blackbox data, and extracts mechanical data related to the traffic accident (e.g., mechanical parameters such as the collision speed, the collision quantity, the motion quantity, the centrifugal force, the traveling direction, and the post-collision turn direction of the vehicle) and mechanical factors affecting the traffic accident.

The accident reconstructer 340 extracts motion-related vectors of the accident-involved objects from the extracted mechanical data and applies the mechanical data and the motion-related vectors to the virtual accident environment to virtually reconstruct the traffic accident.

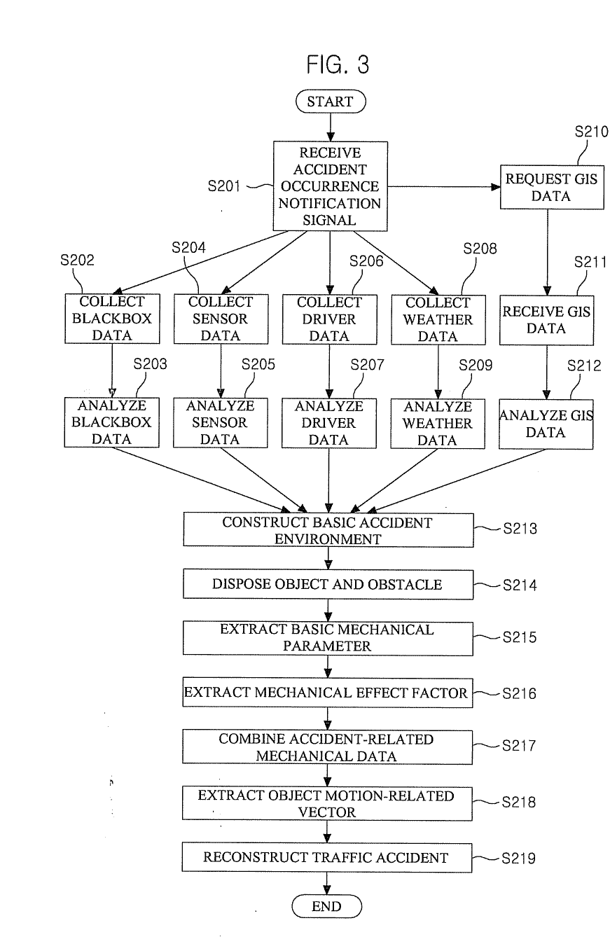

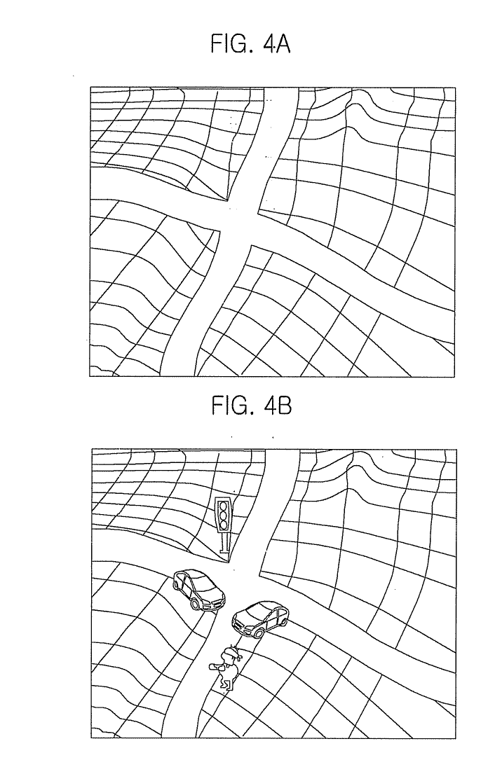

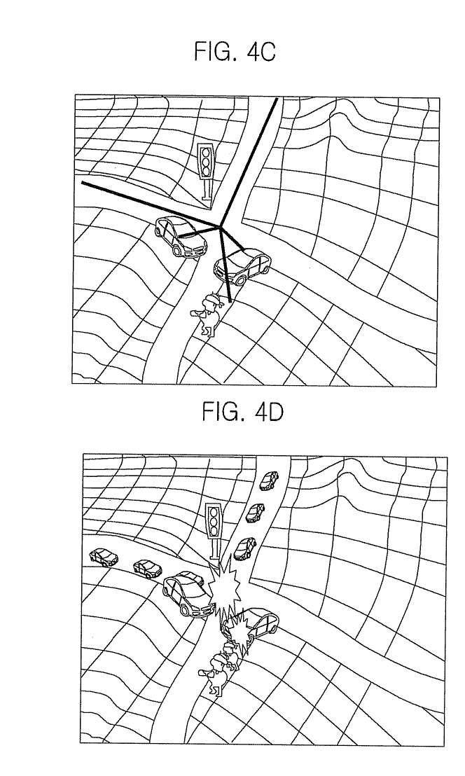

For conciseness and convenience in description, the detailed operations of the accident environment constructer 320, the mechanical data extractor 330, and the accident reconstructer 340 will be described later with reference to FIGS. 3 and 4.

Hereinafter, an operational process according to the aforesaid exemplary embodiment will be described in detail with reference to the accompanying drawings.

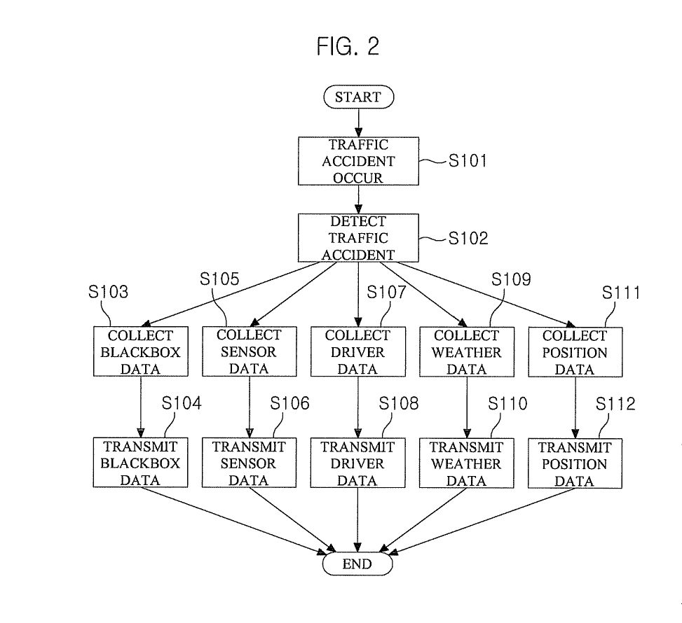

FIG. 2 is a flow diagram illustrating data collecting operations for a traffic accident reconstructing process according to an exemplary embodiment. FIG. 3 is a flow diagram illustrating data analyzing operations and accident reconstructing operations for the accident reconstructing process according to an exemplary embodiment. FIGS. 4A to 4D are diagrams illustrating a process for reconstructing a traffic accident by constructing a virtual accident environment according to an exemplary embodiment.

Referring to FIGS. 2 and 3, an accident reconstructing process according to an exemplary embodiment includes data collecting steps S101 to S112, data analyzing steps S201 to S212, and accident reconstructing steps S213 to S219.

It is preferable that the data collection is performed during the vehicle driving independently of a traffic accident. It is possible that the vehicle status data, the vehicle driving data (e.g., the blackbox data), the driver data (e.g., the physical status data of the drivers), and the external condition data (e.g., the roadside sensor data) are collected only immediately after the traffic accident or only upon detection of sudden braking or a sudden turn. However, it is preferable that the respective data collectors 110 to 150 collect the corresponding data at all times during the vehicle driving to obtain sufficient data for reliable accident reconstruction.

Thus, the data collecting steps S101 to S112 of FIG. 2 correspond to a process of extracting accident-related data from the data collected by the respective data collectors 110 to 150 after the traffic accident. Therefore, in the following description, it should be noted that the terms ‘data collection’ in the steps S101 to S112 denote a process of extracting the accident-related data (e.g., the blackbox data before/after the accident time and the GIS data in the neighborhood of the accident area) from the data collected by the respective data collectors 110 to 150.

Referring to FIG. 2, when a traffic accident occurs (S101), the vehicle blackbox 110 or the roadside sensor 120 detects the traffic accident (S102) and collects/transmits data related to the traffic accident.

Specifically, the vehicle blackbox 110 installed in the vehicle extracts the blackbox data for a certain time interval around the time of the accident (e.g., from 3 minutes before the accident to 30 seconds after the accident) (S103), and transmits the extracted data to the accident analyzing center 300 (S104).

Herein, each of the blackboxes 110 installed in all the vehicles involved in the traffic accident transmits the aforesaid data to the accident analyzing center 300.

Preferably, the blackbox data also include image data of external environments around the vehicle, which are captured by the cameras installed at the periphery of the vehicle. The image data are captured at various angles in the periphery of the vehicle. The image data include data of other vehicles, people, and objects that approach the vehicle. Therefore, the image data may be conveniently used to analyze the causes of the traffic accident.

The roadside sensor 120 collects accident circumstance data according to the detection of roadside conditions (S105) and transmits the accident circumstance data to the accident analyzing center 300 (S106).

Herein, the roadside sensor 120 may detect the accident traffic by itself, or by receiving the corresponding signal from the accident vehicle, or by the accident notification of the accident analyzing center 300. The collection data type, the data collection method, the accident detection method, and the data transmission method of the roadside sensor 120 are already described above, and thus a detailed description thereof will be omitted for conciseness.

The driver data collector 130 collects driver data related to the traffic accident (e.g., the vehicle driving patterns and the physical status of the drivers) (S107), extracts the driver data for a certain time interval aroung the time of the accident (e.g., from 3 minutes before the accident to 30 seconds after the accident) (S103), and transmits the extracted driver data to the accident analyzing center 300 (S108).

The weather data collector 140 collects the weather data in the neighborhood of the accident site from a satellite or a database of the national meteorological administration at the request of the accident analyzing center 300 (S109), and transmits the collected weather data to the accident analyzing center 300 (S110).

The position data collector 150 collects accident site data through the GPS (S111), and transmits the accident site data to the accident analyzing center 300 (S112).

The data analyzing steps S201 and S212 are performed after the data collecting steps S101 to S112.

Referring to FIG. 3, the accident analyzing center 300 is notified of the accident occurrence, for example, by receiving an accident occurrence notification signal from the accident vehicle or the roadside sensor 120 (S201). Then, the accident analyzing center 300 requests the GIS 200 to transmit the geographical data of the neighborhood of the accident site (S210), and receives the geographical data from the GIS 200 (S211).

Thereafter, the accident data analyzer 310 of the accident analyzing center 300 receives the respective data (e.g., the blackbox data, the driver data, the weather data, and the position data) from the data collecting unit 100, and extracts/analyzes the accident-related data.

Specifically, the blackbox data analyzer 311 receives the driving data and the status data of the accident vehicle from the vehicle blackbox 110 (S202), and analyzes whether any internal control and the corresponding motion existed at the accident time on the basis of the vehicle driving data (e.g., the vehicle component status data, the engine status data, the self-diagnosis data, the vehicle speed data, and the vehicle direction data) (S203). If the image data are included in the blackbox data, the blackbox data analyzer 311 also analyzes how an accident-causing object approached the vehicle to affect the traffic accident and how it is related to the internal operation of the vehicle (S203).

The sensor data analyzer 312 receives the external condition data from the roadside sensor 120 (S204), and analyzes the accident circumstance data (e.g., data on the status of nearby traffic lights, the surface status of the road, peripheral road construction conditions, the conditions of previous accidents, if any, and the driving speed limit at the accident time) and data on the status of victims and vehicles before/after the traffic accident, on the basis of the received external condition data (S205).

The driver data analyzer 313 receives the driver data from the driver data collector 130 (S206), and analyzes the vehicle driving patterns and the physical status of the driver (e.g., the drowsy status and the fatigue status inferred from a change in the posture and the driving posture of the driver), on the basis of the received driver data (S207).

The weather data analyzer 314 receives the weather data of the neighborhood of the accident site from the weather data collector 140 (S208), and analyzes weather factors (e.g., fog, rainfall, snowfall, thunder, and lightning) on the basis of the received weather data to analyze the influence of the weather status on the traffic accident (S209).

The position data analyzer 315 receives the vehicle position data for a certain period (e.g., 3 minutes) before the accident time from the position data collector 150 and receives the geographical data of the neighborhood of the accident site from the GIS 200 (S211). Thereafter, the position data analyzer 315 analyzes the trajectory of the movement of the vehicle to the accident site on the basis of the received vehicle position data and analyzes the geographical data of the accident area (e.g., the sharp curve of the road) received from the GIS 200 to analyze the physical effects according to the geographical features (e.g., the direction and the magnitude of centrifugal force applied thereto) (S212). The position data analyzer 315 transmits the analysis results and the geographical data received from the GIS 200 to the accident environment constructer 320 and the mechanical data extractor 330.

The accident reconstructing steps S213 to S219 are performed after completion of the data analysis through the data analyzing steps S202 to S212.

First, an accident occurrence environment is constructed on the basis of the analysis results. Specifically, as illustrated in FIG. 4A, a three-dimensional basic accident environment is constructed on the basis of the position data, the geographical data, and the weather data (S213). Facts related to the weather data are not represented in the exemplary accident environment of FIG. 4A. However, it is preferable that the accident environment is configured to include weather data (e.g., humidity and temperature) related to the traffic accident, and the weather conditions (e.g., heavy fog, rainfall, and snowfall) that may directly cause the traffic accident.

The inclusion of the weather data may be implemented by representing snowfall and rainfall graphically, or by displaying numeral data of the rainfall, the snowfall, the view distance, the temperature and the humidity at a certain position on the screen.

Thereafter, as illustrated in FIG. 4B, a virtual accident environment is constructed by arranging accident-involved objects (i.e., accident-involved vehicles, obstacles, and pedestrians) in the basic accident environment on the basis of the position data of the accident-involved vehicle and the neighborhood data of the accident site received from the sensor data analyzer 312 (S214).

Thereafter, as illustrated in FIG. 4C, the mechanical parameters of the vehicle (e.g., the collision speed, the collision quantity, the motion quantity, the centrifugal force, the traveling direction, and the post-collision turn direction of the vehicle) are extracted from the analysis results of the sensor data, the driver data, the weather data, the position data, the geographical data, and the data analyzed on the basis of the blackbox data (S215); and mechanical factors directly affecting the traffic accident are extracted from the collected/analyzed data (S216).

For example, in the event of a vehicle overturn accident, the centrifugal force applied to the vehicle immediately before the accident time and the speed of the vehicle may be extracted as the mechanical factors. On the basis of the extracted mechanical data, the correlation between the accident-involved objects may be graphically represented as illustrated in FIG. 4C.

A traffic accident may be caused not only by the aforesaid physical factors but also by drowsy driving, careless driving, reckless driving, bad weather, and poor road surface status. Therefore, it is preferable that the mechanical factors are extracted by synthetically considering the weather data analysis results, the geographical data analysis results, the analysis results of the external condition data received from the roadside sensor 120, and the driver data collected/analyzed by the driver data collector 130/the driver data analyzer 313.

Next, the extracted mechanical data (e.g., the mechanical parameters and the mechanical factors) are synthesized (S217), and the motion vectors of the accident-involved objects are extracted (S218). Then, as illustrated in FIG. 4D, the traffic accident is virtually reconstructed on the basis of the extracted mechanical data and the extracted motion vectors (S219). It is preferable that the conditions from a few minutes (e.g., 3 minutes) before the accident time are reconstructed for reconstruction of the traffic accident.

Hereinafter, for further understanding of the present invention, a specific example is given with reference to a traffic accident exemplified in FIGS. 4A to 4D.

As regarding an exemplary traffic accident exemplified in FIG. 4A to 4D, on a dry and clear day, a vehicle traveling from the north toward the accident site (which is shown on the right side of FIG. 4D and hereinafter referred to as the southbound vehicle) and another vehicle traveling from the west toward the accident site (which is shown on the left side of FIG. 4D and hereinafter referred to as the eastbound vehicle) collided with each other (a primary accident) and then caused a collision with a pedestrian (a secondary accident). Herein, the accident site was an intersection with traffic lights, and the pedestrian was walking on an adjacent sidewalk. A small hill can be seen in the proximity of the intersection but did not obstruct the views of the drivers of the two accident-involved vehicles.

It is assumed that the driver of the eastbound vehicle fell asleep at the wheel and failed to see a red light, and the westbound vehicle entered the intersection first. Thus, it is assumed that the eastbound vehicle collided against the right, front end of the southbound vehicle, causing the southbound vehicle to suddenly swerve and hit the pedestrian.

In the event of the above traffic accident, the vehicle blackbox 110 installed in each of the two accident-involved vehicles transmits vehicle status data (e.g., engine status data, component status data, and self-diagnosis data) and vehicle driving data (e.g., driving speed data and driving direction data) to the accident analyzing center 300. Also, the driver data collector 130 transmits physical status data of the driver (e.g., eyelid bat data and driving posture change cycle data) to the accident analyzing center 300. If cameras are installed outside the vehicle, image data of the neighborhood of the vehicle are also transmitted to the accident analyzing center 300. Also, the position data collector 150 transmits vehicle position data to the accident analyzing center 300.

When one or more roadside sensor 120 around the intersection detects the traffic accident by itself or by the signal or command of the accident vehicle or the accident analyzing center 300, the external condition information (e.g., the image data of the neighborhood of the accident site, the traffic status data of the accident road, the road surface status data, and the peripheral road construction status data) are transmitted to the accident analyzing center 300.

Preferably, the aforesaid data are not momentary data immediately after the accident time but data for a certain time interval around the time of the accident (e.g., from 3 minutes before the accident time to 30 seconds after the accident time).

The accident analyzing center 300 receives the weather data and the geographical data from the weather data collector 140 and the GIS 200 while receiving the aforesaid data.

Thereafter, the accident analyzing center 300 analyzes the received data. Specifically, the accident analyzing center 300 analyzes the accident vehicle position data and the geographical data to detect the geographical position relationship of the accident site. Also, the accident analyzing center 300 analyzes the drowsy status of the drivers, the time-dependent positions of the two accident-involved vehicles, the speeds of the vehicles (i.e., the over-speed status of the vehicles), the directions of the vehicles, the traffic light status of the neighborhood of the accident site, the weather status, the road surface status, and the road curve status) to detect factors that may affect the traffic accident. Particularly, if the image data are received from the roadside sensor 120, the accident analyzing center 300 may immediately detect the status of the traffic lights, the movement trajectories of the accident-involved vehicles, and which of the two accident-involved vehicles entered the intersection first.

The accident environment constructer 320 constructs a virtual accident environment on the basis of the analysis results of the weather data and the geographical data, and arranges the accident-involved objects (e.g., the two accident-involved vehicles, the pedestrian, the traffic lights, and the small hill neighboring on the accident site) in the virtual accident environment by synthesizing the aforesaid analysis results.

Thereafter, the mechanical data of each vehicle is extracted by synthesizing the status data of each vehicle, the driving data, the external condition data, the driver data, the weather data, the geographical data, and the vehicle movement trajectory data; and the accident circumstances from a certain time before the accident time (e.g., 3 minutes before the accident time) are reconstructed on the basis of the extracted data.

The reconstruction of the traffic accident is basically performed on the basis of the stationary states and the physical movements of the respective accident-involved objects (e.g., vehicles, pedestrians, geographical objects, and roads). Still, it is preferable that the reconstruction of the traffic accident is further based on the analysis results of the driver data, the weather data, the geographical data, and the road surface data to detect accident causes more accurately.

In the case of the reconstruction of the exemplary traffic accident, those of ordinary skill in the art will readily understand that the exemplary embodiment can reconstruct the driver status as well as the speeds and directions of the two accident-involved vehicles entering the intersection, the entry order, and the traffic light status at that time, and simulate the movement trajectories of the accident-involved vehicles immediately before/after the accident time by extraction of the related motion vectors without any manual operation.

The direct cause of the exemplary traffic accident is the drowsy driving of the driver, but it may not be easily detected solely by the internal/external physical data of the vehicles. However, the exemplary embodiment can clearly detect the accident cause and the fault existence by also analyzing/considering the driver data.

The overlapping data may be received from the respective data collectors 110 to 150 (for example, the position data of the accident vehicle may be collected/transmitted by all three of the position data collector, the roadside sensor, and the blackbox installed in each of one or more accident-involved vehicles), or the correlated data may be transmitted through the different data collectors. Therefore, these facts may be used to verify the received data or the analysis results of the respective data analyzers, thereby making it possible to further increase the reconstruction reliability. For example, when the data transmitted from the driver data collector 130 are analyzed to detect that the driver of the eastbound vehicle fell asleep at the wheel and the intersection entry image and the traffic light status data obtained from the roadside sensor 120 are analyzed to detect that the eastbound vehicle neglected the traffic lights and collided against the southbound vehicle that entered the intersection first, it may be verified that the primary cause of the traffic accident was the drowsy driving of the driver of the eastbound vehicle.

Although not illustrated in FIG. 4D, the driver status data, the weather status data and the road surface status data may be represented in addition to the stationary state data and the physical movement data of the accident-involved objects, or the driver status and the peripheral conditions as well as the physical states of the accident-involved objects may be reconstructed in such a way as to highlight only the factors related to the direct cause of the traffic accident. For example, because the main cause of the exemplary traffic accident is the drowsy driving of the driver, the direct cause of the traffic accident may be clearly represented in such a way as to display data of the main cause at a certain position of the screen.

As mentioned in the description of the background art, the accident circumstance reconstruction method of the related art using a vehicle blackbox reconstructs the circumstances of a traffic accident solely on the basis of internal vehicle data and, therefore, it has a limitation in accurate reconstructing of the complete accident circumstances, which inevitably involve the external factors. In addition, the traffic accident is investigated after movement of the accident-involved vehicles or after a long time from the accident time, or it is performed on the basis of inaccurate data such as witness statements, which makes it difficult to accurately reconstruct the complete accident circumstances.

However, the exemplary embodiments may automatically reconstruct virtual, complete accident circumstances considering all the factors of the traffic accident, without site investigation, on the basis of the vehicle blackbox data, the position data, the geographical data (i.e., the GIS data), the sensor data, and the weather data, thus making it possible to easily detect the causes of the traffic accident.

Various modifications may be made in the exemplary embodiments. For example, although the functional modules of the respective data collectors or the respective data analyzers have been described in a separate manner, their physical arrangement is not limited thereto. For example, the position data collector 150 may be included in the blackbox 110 and the mechanical data extractor 330 may be included in the position data analyzer 315 or other data analyzers. Also, the accident environment constructer 320, the mechanical data extractor 330, and the accident reconstructer 340 may be integrated into one unit. Also, all the functional modules of the exemplary embodiments may be implemented in one chip in a hardware manner, or may be implemented by the software running in a general-purpose processor.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

1. A system for reconstructing a traffic accident, comprising:
a data collecting unit collecting/transmitting accident-related data according to an occurrence of a traffic accident;
a geographical data providing unit transmitting geographical data of a neighborhood of an accident site; and
an accident analyzing unit reconstructing the traffic accident on the basis of the data outputted from the data collecting unit and the geographical data providing unit.

2. The system of claim 1, wherein the data collecting unit comprises a vehicle blackbox installed in each of one or more accident-involved vehicles to detect the traffic accident and collect/transmit vehicle status data and vehicle driving data.

3. The system of claim 2, wherein the data collecting unit further comprises at least one of:
a roadside sensor collecting/transmitting external condition data around the accident-involved vehicle at the time of an accident;
a vehicle data collector collecting driver data related to the traffic accident;
a weather data collector collecting weather data of the accident site; and
a position data collector collecting accident site data of the accident-involved vehicles through a Global Positioning System (GPS).

4. The system of claim 1, wherein the accident analyzing unit comprises:
an accident data analyzer analyzing the accident-related data received from the data collecting unit for reconstruction of the traffic accident;
an accident environment constructer constructing an accident environment of the neighborhood of the accident site on the basis of an analysis result of the accident data analyzer;
a mechanical data extractor extracting mechanical data related to the traffic accident on the basis of the analysis result of the accident data analyzer; and
an accident reconstructer reconstructing the traffic accident by applying mechanical data to the constructed accident environment.

5. The system of claim 4, wherein the accident data analyzer comprises at least one of:
a blackbox data analyzer analyzing driving data and status data of each of one or more accident-involved vehicles;
a sensor data analyzer analyzing external condition data including data on peripheral obstacles, traffic light status, and road conditions around the accident site;
a driver data analyzer analyzing a driving pattern and physical status of a vehicle driver;
a weather data analyzer analyzing weather factors affecting the traffic accident; and
a position data analyzer analyzing movement trajectories of the accident-involved vehicles on the basis of the accident site data and the geographical data.

6. The system of claim 4, wherein the accident environment constructer constructs a basic accident environment on the basis of the position data of the accident-involved vehicles and the geographical data around the accident site, and constructs a virtual accident environment by arranging accident-involved objects in the basic accident environment.

7. A method for automatically reconstructing a traffic accident, comprising:
collecting accident-related data according to an occurrence of a traffic accident;
analyzing necessary data extracted from the accident-related data; and
reconstructing the traffic accident virtually on the basis of the analyzed data.

8. The method of claim 7, wherein the collecting of accident-related data comprises:
collecting status data and driving data of one or more accident-involved vehicles upon detecting a traffic accident and;
collecting geographical data of a neighborhood of an accident site.

9. The method of claim 7, wherein the reconstructing of the traffic accident comprises:
constructing a basic accident environment on the basis of position data and geographical data of an accident site among the analyzed data; and
constructing a virtual accident environment by arranging accident-involved objects in the basic accident environment on the basis of the position data of the accident-involved objects among the analyzed data.

10. The method of claim 9, wherein the reconstructing of the traffic accident further comprises:
extracting mechanical parameters of the accident-involved objects and mechanical factors affecting the traffic accident; and
reconstructing the accident circumstances by applying the mechanical parameters and the mechanical factors to the virtual accident environment.

11. The system of claim 1, wherein the accident data analyzer comprises:
a blackbox data analyzer analyzing driving data and status data of each of one or more accident-involved vehicles;
a sensor data analyzer analyzing external condition data including data on peripheral obstacles, traffic light status, and road conditions around the accident site;
a driver data analyzer analyzing a driving pattern and physical status of a vehicle driver;
a weather data analyzer analyzing weather factors affecting the traffic accident; and
a position data analyzer analyzing movement trajectories of the accident-involved vehicles on the basis of the accident site data and the geographical data.

12. The system of claim 1, wherein the accident data analyzer comprises at least one of:
a blackbox data analyzer analyzing driving data and status data of each of one or more accident-involved vehicles;
a sensor data analyzer analyzing external condition data including data on peripheral obstacles, traffic light status, and road conditions around the accident site;
a driver data analyzer analyzing a driving pattern and physical status of a vehicle driver;
a weather data analyzer analyzing weather factors affecting the traffic accident; and
a position data analyzer analyzing movement trajectories of the accident-involved vehicles on the basis of the accident site data and the geographical data.
